(19) United States
(12) Patent Application Publication
(10) Pub. No.: US 2008/0030417 A1
(43) Pub. Date: Feb. 7, 2008

(54) Antenna Apparatus

(76) Inventors: Yoji Aramaki, Tokyo (JP); Naofumi Yoneda, Tokyo (JP); Yoshihiko Konishi, Tokyo (JP); Izuru Naito, Tokyo (JP); Toshiyuki Horie, Tokyo (JP); Shuji Nuimura, Tokyo (JP)

Correspondence Address: BIRCH STEWART KOLASCH & BIRCH, PO BOX 747, FALLS CHURCH, VA, 22040-0747, US

(21) Appl. No.: 11/659,367

(22) PCT Filed: Dec. 13, 2004
(86) PCT No.: PCT/JP04/18585

§ 371 Date: Feb. 5, 2007

(30) Foreign Application Priority Data
Dec. 13, 2004 (JP) 20041213

(51) Int. Cl. H01Q 13/00

(52) U.S. Cl. 343/779

(57) ABSTRACT

A disk-shaped reflecting plate 3 for reflecting an electric wave emitted out of an aperture 1a of a circular waveguide 1 is placed a location which is just opposite to the aperture 1a of the circular waveguide 1, and a ring-shaped waveguide 4 for shaping the radiation characteristic of the electric wave reflected by the disk-shaped reflecting plate 3 to a rotational symmetrical radiation characteristic is disposed around the perimeter of the disk-shaped reflecting plate 3. Thereby, even when many grooves 4a need to be formed in order to make the electric wave have a rotational symmetrical radiation characteristic, it is not necessary to increase the size of the disk-shaped reflecting plate 3 in the direction of its radius.

### FIELD OF THE INVENTION

The present invention relates to an antenna apparatus which mainly transmits or receives an electric wave lying within a VHF band, a UHF band, a microwave band, or a millimeter wave band.

### BACKGROUND OF THE INVENTION

In prior art antenna apparatus, a disk-shaped subreflector for reflecting an electric wave emitted out of an aperture of a waveguide is placed at a location which is just opposite to the aperture of the waveguide, and a main reflector for reflecting the electric wave reflected by the subreflector is placed at a location which is just opposite to the subreflector.

However, distortion occurs in the radiation characteristic of the electric wave emitted out of the aperture of the waveguide under the influence of the waveguide which is an electric wall.

Then, in order to shape the radiation characteristic of the electric wave to a rotational symmetrical radiation characteristic, a groove having a depth which is one quarter the wavelength of the electric wave is formed in the reflecting surface of the subreflector (for example, refer to patent reference 1).

Therefore, since this antenna apparatus can produce an electric wave having a substantially-rotational symmetrical radiation characteristic, high gain can be achieved, reduction in the cross polarization can be made, and reduction in the side lobe level can be made.

However, depending on the frequency of the electric wave, it is necessary to form many grooves in the reflecting surface of the subreflector in order to produce an electric wave having a rotational symmetrical radiation characteristic. In this case, the size of the subreflector in the direction of the radius thereof increases.

The result is that since most of the electric wave reflected by the main reflector hits the subreflector, the side lobe level increases and hence the gain reduces.

Another prior art antenna apparatus which uses a subreflector which is shaped like an umbrella and which has an edge portion located below its central portion is disclosed by nonpatent reference 1 mentioned below.

This prior art antenna apparatus has a commonality with the above-mentioned prior art antenna apparatus in that a groove is formed in the reflecting surface of the subreflector so that the depth of the groove extends along a perpendicular direction.

Therefore, depending on the frequency of the electric wave, it is necessary to form many grooves in the reflecting surface of the subreflector in order to produce an electric wave having a rotational symmetrical radiation characteristic. In this case, the size of the subreflector in the direction of the radius thereof increases.

In an antenna apparatus disclosed by patent reference 2 mentioned below, a parallel plate radial waveguide in which a groove having a depth which is one quarter the wavelength of an electric wave at a certain frequency is formed at an end of the waveguide is disposed in order to make the electric wave have a rotational symmetrical radiation characteristic.

Therefore, depending on the frequency of the electric wave, it is necessary to form many grooves in the parallel plate radial waveguide in order to produce an electric wave having a rotational symmetrical radiation characteristic. In this case, the size of the primary radiator in the direction of the radius thereof increases.

This patent reference 2 also discloses an antenna apparatus which uses a radial waveguide which is shaped like an umbrella and which has an edge portion located below its central portion. In this case, it is necessary to also form a groove having a depth which is one quarter the wavelength of the electric wave at a certain frequency at an outer surface of the waveguide which is another plate of the radial waveguide, and therefore the radial waveguide increases inevitably in size in the direction of the radius thereof.

Patent reference 1: JP, 1-500790,A (see pages 3 to 4, and FIG. 6)

Patent reference 2: U.S. Pat. No. 3,162,858

Nonpatent reference 1: “FDTD design of a Chinese hat feed for shallow mm-wave reflector antennas”, written by Yang, J.; Kildal, P.-S, Antennas and Propagation Society International Symposium, 1988. IEEE, Volume: 4, 21-26 Jun. 1998, P2046-2049 vol. 4

A problem with prior art antenna apparatus constructed as mentioned above is that when it is necessary to form many grooves in a subreflector in order to produce an electric wave having a rotational symmetrical radiation characteristic, the size of the subreflector in the direction of the radius thereof increases and therefore most of the electric wave reflected by a main reflector hits the subreflector, the side lobe level increases and hence the gain reduces.

The present invention is made in order to solve the above-mentioned problem, and it is therefore an object of the present invention to provide an antenna apparatus which can achieve high gain, can make a reduction in the cross polarization, and can make a reduction in the side lobe level.

### DISCLOSURE OF THE INVENTION

In an antenna apparatus in accordance with the present invention, a disk-shaped reflecting plate for reflecting an electric wave emitted out of an aperture of a first waveguide is placed at a location which is just opposite to the aperture of the first waveguide, and a ring-shaped second waveguide for shaping the radiation characteristic of the electric wave reflected by the disk-shaped reflecting plate to a rotational symmetrical radiation characteristic is disposed around the perimeter of the disk-shaped reflecting plate.

Thereby, even when many grooves need to be formed in order to make the electric wave have a rotational symmetrical radiation characteristic, it is not necessary to increase the size of the reflecting plate in the direction of its radius. For this reason, the existence of the reflector does not increase the side lobe level, and does not cause any reduction in the gain, and hence high gain can be achieved, reduction in the cross polarization can be made, and reduction in the side lobe level can be made.

The antenna apparatus in accordance with the present invention greatly differs from prior art antenna apparatus disclosed in patent reference 1 and nonpatent reference 1, which form a rotational symmetric pattern when reflecting an electric wave using a reflecting plate, in this point, and can produce a rotational symmetric radiation pattern without increasing the size of the reflecting plate in the direction of its radius. Since the antenna apparatus does not need to have a groove formed in the outer surface of the waveguide and having a depth which is one quarter the wavelength of the electric wave at a certain frequency, unlike that disclosed in patent reference 2, the antenna apparatus can produce a rotational symmetric radiation pattern without increasing the size of the reflecting plate in the direction of its radius. For this reason, the existence of the reflector does not increase the side lobe level, and does not cause any reduction in the gain, and hence high gain can be achieved, reduction in the cross polarization can be made, and reduction in the side lobe level can be made.

### BRIEF DESCRIPTION OF THE FIGURES

FIG. 1 is a block diagram showing an antenna apparatus in accordance with embodiment 1 of the present invention;

FIG. 2 is a block diagram showing an antenna primary radiator of the antenna apparatus in accordance with embodiment 1 of the present invention;

FIG. 3 is an explanatory diagram showing an electric field direction when viewed from a side or an upper surface of a circular waveguide;

FIG. 4 is an explanatory diagram showing the action of a magnetic wall;

FIG. 5 is an explanatory diagram showing shaping of the radiation characteristic of an electric wave to a rotational symmetrical one;

FIG. 6 is an explanatory diagram showing a relationship between the depth of each groove and the action of the magnetic wall;

FIG. 7 is a block diagram showing an antenna apparatus in accordance with embodiment 2 of the present invention;

FIG. 8 is a block diagram showing an antenna primary radiator of the antenna apparatus in accordance with embodiment 2 of the present invention;

FIG. 9 is a block diagram showing an antenna primary radiator of an antenna apparatus in accordance with embodiment 3 of the present invention;

FIG. 10 is a top plan view showing the antenna primary radiator of the antenna apparatus in accordance with embodiment 3 of the present invention;

FIG. 11 is a block diagram showing an antenna primary radiator of an antenna apparatus in accordance with embodiment 4 of the present invention;.

FIG. 12 is a block diagram showing the antenna primary radiator of the antenna apparatus in accordance with embodiment 4 of the present invention;

FIG. 13 is a block diagram showing an antenna apparatus in accordance with embodiment 5 of the present invention;

FIG. 14 is an enlarged block diagram showing a main part of a circular waveguide; and

FIG. 15 is an enlarged block diagram showing the main part of the circular waveguide.

### PREFERRED EMBODIMENTS OF THE INVENTION

Hereafter, in order to explain this invention in greater detail, the preferred embodiments of the present invention will be described with reference to the accompanying drawings.

### Embodiment 1

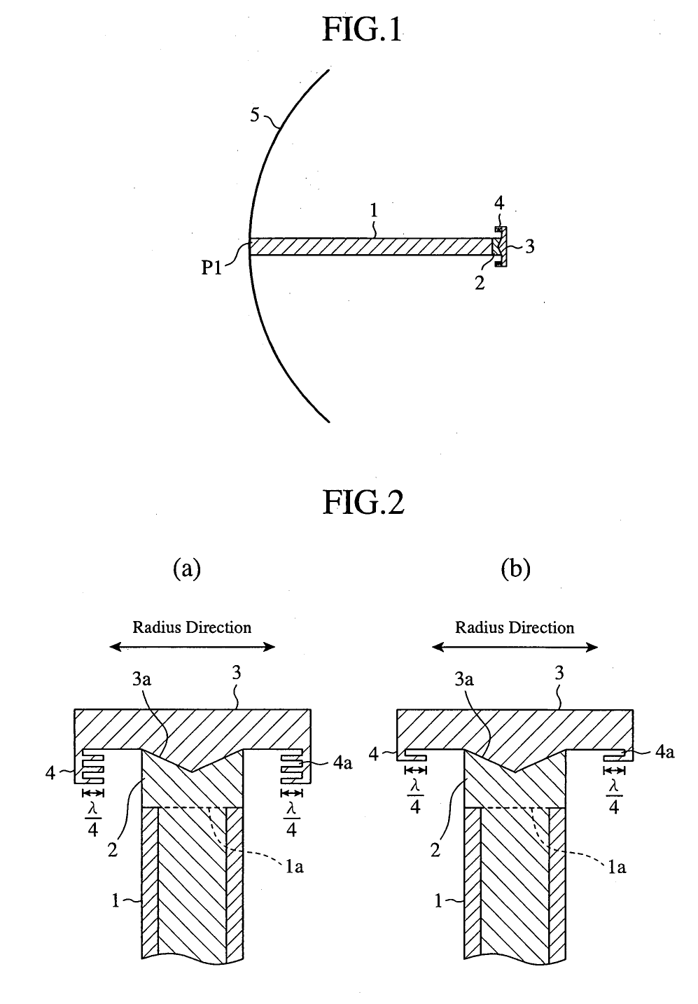

FIG. 1 is a block-diagram showing an antenna apparatus in accordance with embodiment 1 of the present invention, and FIG. 2 is a block diagram showing an antenna primary radiator of the antenna apparatus in accordance with embodiment 1 of the present invention. FIGS. 1 and 2 are cross-sectional views for explaining the structure of the antenna apparatus in accordance with embodiment 1 of the present invention.

In the figures, when receiving an electric wave of a basic mode (i.e., a circular-waveguide TE₁₁ mode) from a terminal P1, a circular waveguide 1 which is a first waveguide transmits the electric wave and emits out the electric wave from an aperture 1a thereof.

A dielectric member 2 has an end which is inserted into the interior of the circular waveguide 1, and another end of the dielectric member 2 which is not inserted into the circular waveguide 1 is attached to a disk-shaped reflecting plate 3.

The disk-shaped reflecting plate 3 is placed at a location which is just opposite to the aperture 1a of the circular waveguide 1, and reflects the electric wave emitted out of the aperture 1a of the circular waveguide 1 toward a main reflector 5. A metallic projection 3a is disposed at a central part of a reflecting surface of the reflecting plate 3.

A ring-shaped waveguide 4, which is a second waveguide, is disposed around the perimeter of the disk-shaped reflecting plate 3, and shapes the radiation characteristic of the electric wave reflected by the reflecting plate 3 to a rotational symmetrical radiation characteristic.

A plurality of grooves 4a are formed in an inner surface of the ring-shaped waveguide 4 so that their depths extend along the radius of the reflecting plate, and the depth of each of the plurality of grooves is one quarter the wavelength of the electric wave at a used frequency.

The radiation waveguide of the primary radiator is constructed of the disk-shaped reflecting plate 3, metallic projection 3a, and ring-shaped waveguide 4.

The main reflector 5 is placed at a location which is just opposite to the disk-shaped reflecting plate 3, and reflects the electric wave whose radiation characteristic has been shaped by the ring-shaped waveguide 4.

Next, the operation of the antenna apparatus in accordance with this embodiment of the present invention will be explained.

First, when an electric wave of a basic mode is inputted to the antenna apparatus from the terminal P1 of the circular waveguide 1, the electric wave is made to propagate through the interior of the circular waveguide 1 and to then emerge from the aperture 1a of the circular waveguide 1 toward the disk-shaped reflecting plate 3.

At that time, since the circular waveguide 1 is made from a metallic material, the circular waveguide 1 acts as an electric wall for the electric wave when the electric wave is furnished to the interior of the circular waveguide 1.

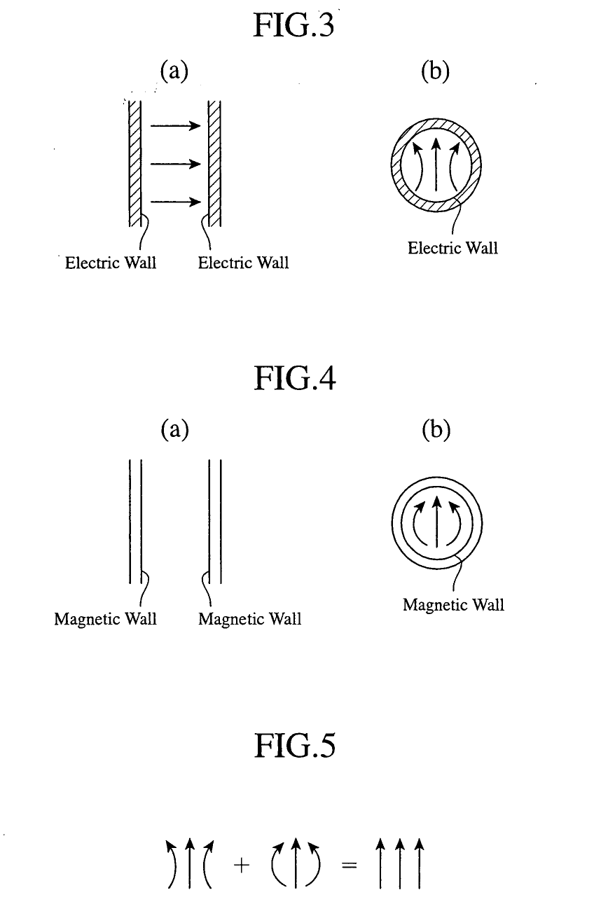

By virtue of the action of the electric wall, distortion as shown in FIG. 3 occurs in the electric field direction of the electric wave which propagates through the interior of the circular waveguide 1. FIG. 3(a) shows the electric field direction when viewed from a side of the circular waveguide 1, and FIG. 3(b) shows the electric field direction when viewed from an upper surface of the circular waveguide 1.

In the example of FIG. 2(a), since the dielectric member 2 is inserted into the interior of the circular waveguide 1, the electric wave inputted to the antenna apparatus from the terminal P1 of the circular waveguide 1 is made to propagate through the dielectric member 2 disposed in the circular waveguide 1. Therefore, the pipe diameter of the circular waveguide 1 can be made thinner as compared with a case where the interior of the circular waveguide 1 is hollow.

The electric wave emitted out of the aperture 1a of the circular waveguide 1 is reflected by the disk-shaped reflecting plate 3, and most of the electric wave is emitted toward the main reflector 5.

Since the metallic projection 3a is disposed at the central part of the reflecting plate 3, the electric wave emitted out of the aperture 1a of the circular waveguide 1 and reflected by the reflecting plate 3 hardly returns to the circular waveguide 1.

Although the electric wave reflected by the disk-shaped reflecting plate 3 has become distorted in the electric field direction thereof, the distortion in the electric field direction is removed by the ring-shaped waveguide 4 since the ring-shaped waveguide 4 is disposed around the perimeter of the disk-shaped reflecting plate 3, so that the radiation characteristic of the electric wave is shaped to a rotational symmetrical one.

That is, the plurality of grooves 4a are formed in the inner surface of the ring-shaped waveguide 4 so that their depths extend along the radius of the reflecting plate, and the depth of each of the plurality of grooves 4a is one quarter the wavelength of the electric wave at a used frequency. Therefore, as shown in FIG. 4(a), a magnetic wall in which no current flows is formed in the inner surface of the ring-shaped waveguide 4.

By virtue of the action of this magnetic wall, distortion in an opposite direction which cancels out the distortion caused by the action of the electric wall is added to the electric wave passing through the inner side of the ring-shaped waveguide 4 (refer to FIG. 4(b)).

As a result, since the action of the electric wall and the action of the magnetic wall cancel each other out, the distortion in the electric field direction is removed and the radiation characteristic of the electric wave reflected by the reflecting plate is shaped to a rotational symmetrical radiation characteristic, as shown in FIG. 5.

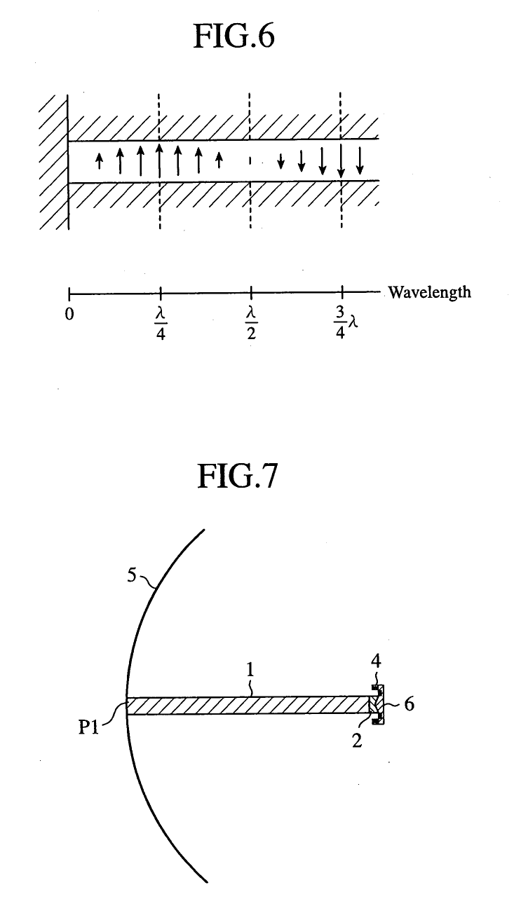

In this embodiment 1, the depth of each of the plurality of grooves 4a is one quarter the wavelength of the electric wave at a used frequency, as previously mentioned. As shown in FIG. 6, when the depth of each of the plurality of grooves 4a is λ/4, 3λ/4, 5λ/4, or . . . , i.e., (2n−1)·λ/4 (n=1, 2, 3, . . . ), the action of the magnetic wall achieves the greatest possible effect. The depth of each of the plurality of grooves 4a does not necessarily need to be one quarter the wavelength of the electric wave at a used frequency, but only has to be (2n−1)·λ/4, where λ is the wavelength of the electric wave.

The electric wave whose radiation characteristic has been shaped to a rotational symmetrical one by the ring-shaped waveguide 4 is reflected by the main reflector 5 and is emitted in a predetermined direction.

The radiation characteristic of the electric wave reflected by the main reflector 5 is a rotational symmetrical one.

On the other hand, in receiving operation, when an electric wave (received electric wave) having a rotational symmetrical radiation characteristic is applied to the main reflector 5 along a predetermined direction, the electric wave is reflected by the main reflector 5 according to the reversibility principle of the antenna apparatus so that it is emitted toward the disk-shaped reflecting plate 3.

At that time, when the electric wave passes through the inner side of the ring-shaped waveguide 4, distortion is added to the electric wave by virtue of the action of the magnetic wall.

The electric wave to which the distortion is added by the ring-shaped waveguide 4 is reflected by the disk-shaped reflecting plate 3 so that it is emitted toward the aperture la of the circular waveguide 1.

The electric wave which has entered the circular waveguide 1 from the aperture la of the circular waveguide 1 propagates through the interior of the circular waveguide 1, and is emitted from the terminal P1.

At that time, when the electric wave propagates through the interior of the circular waveguide 1, distortion in a counter direction which cancels out the distortion caused by the action of the magnetic wall is added to the electric wave by virtue of the action of the electric wall.

As can be seen from the above description, in accordance with this embodiment 1, the disk-shaped reflecting plate 3 for reflecting an electric wave emitted out of the aperture 1a of the circular waveguide 1 is placed at a location which is just opposite to the aperture 1a of the circular waveguide 1, and the ring-shaped waveguide 4 for shaping the radiation characteristic of the electric wave reflected by the disk-shaped reflecting plate 3 to a rotational symmetrical radiation characteristic is disposed around the perimeter of the disk-shaped reflecting plate 3. Thereby, even when many grooves 4a need to be formed in order to make the electric wave have a rotational symmetrical radiation characteristic, it is not necessary to increase the size of the disk-shaped reflecting plate 3 in the direction of its radius. For this reason, the existence of the subreflector does not increase the side lobe level, and does not cause any reduction in the gain, and hence high gain can be achieved, reduction in the cross polarization can be made, and reduction in the side lobe level can be made.

Furthermore, in accordance with this embodiment 1, the plurality of grooves 4a are formed in the inner surface of the ring-shaped waveguide 4 so that their depths extend along the radius of the reflecting plate, and the depth of each of the plurality of grooves is one quarter the wavelength of the electric wave. Therefore, the width of the ring-shaped waveguide 4 in the direction of the radius thereof can be reduced.

In addition, in accordance with this embodiment 1, an end of the dielectric member 2 is inserted into the interior of the circular waveguide 1, and another end of the dielectric member 2 which is not inserted into the circular waveguide 1 is attached to the disk-shaped reflecting plate 3. Therefore, the propagation rate of the electric wave in the circular waveguide 1 is raised and the pipe diameter of the circular waveguide 1 can be made thinner as compared with a case where the interior of the circular waveguide 1 is hollow.

Furthermore, since the disk-shaped reflecting plate 3 is secured to the circular waveguide 1 via the dielectric member 2, no supporting structural element, such as a metallic support, is needed. Therefore, as compared with a case where the disk-shaped reflecting plate 3 is secured to the circular waveguide 1 via a metallic support, the influence of scattering of the eclectic wave from the metallic support etc. is reduced. Therefore, high gain can be achieved, reduction in the side lobe level can be made, and reduction in the side lobe level can be made.

In addition, in accordance with this embodiment 1, since the metallic projection 3a is disposed at the central part of the reflecting plate 3, the electric wave emitted out of the aperture 1a of the circular waveguide 1 hardly returns to the circular waveguide 1, but is emitted into space, and therefore the radiation efficiency of the electric wave can be improved.

In accordance with this embodiment 1, instead of the above-mentioned circular waveguide 1, a rectangular waveguide can be disposed. In this variant, the same advantage can be provided.

Furthermore, as previously explained with reference with the block diagrams, the plurality of grooves 4a are formed in the ring-shaped waveguide 4, and the metallic projection 3a is placed so that its end does not project from the reflecting plate over the end of the ring-shaped waveguide 4. As an alternative, as shown in the FIG. 2(b), when the number of grooves 4a formed in the ring-shaped waveguide is one, the metallic projection 3a can be formed so that its end projects from the reflecting plate over the end of the ring-shaped waveguide 4 and toward the circular waveguide 1. The antenna apparatus of this variant operates in the same way as mentioned above, and can offer the same advantage.

### Embodiment 2

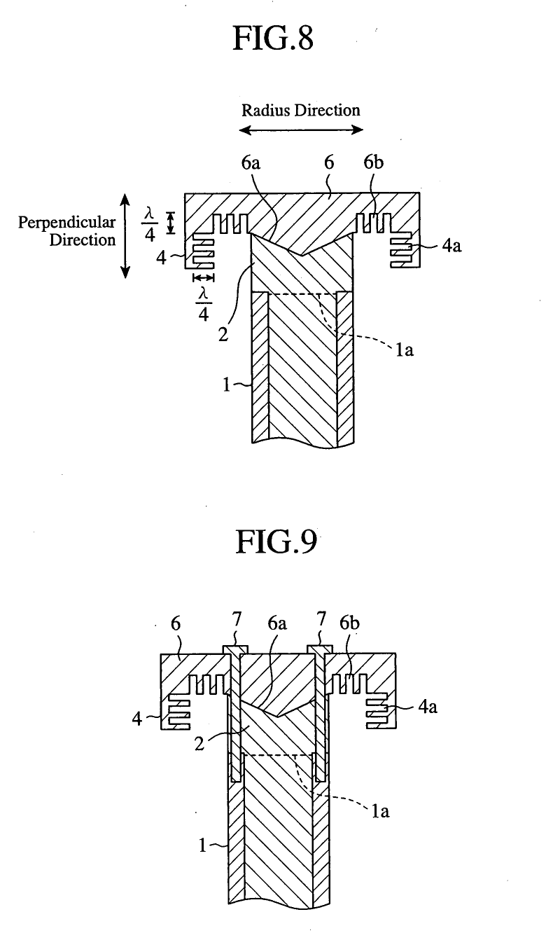

FIG. 7 is a block diagram showing an antenna apparatus in accordance with embodiment 2 of the present invention, and FIG. 8 is a block diagram showing an antenna primary radiator of the antenna apparatus in accordance with embodiment 2 of the present invention.

In the figures, since the same reference numerals as shown in FIGS. 1 and 2 denote the same components or like components, the explanation of the components will be omitted hereafter.

A disk-shaped reflecting plate 6 is placed at a location which is just opposite to an aperture la of a circular waveguide 1, and reflects an electric wave emitted out of the aperture 1a of the circular waveguide 1 toward a main reflector 5. A metallic projection 6a is disposed at a central part of a reflecting surface of the reflecting plate 6.

A plurality of grooves 6a are formed in the reflecting surface of the reflecting plate 6 so that their depths extend along a perpendicular direction, and the depth of each of the plurality of grooves is one quarter the wavelength of the electric wave at a certain frequency.

Next, the operation of the antenna apparatus in accordance with this embodiment of the present invention will be explained.

In above-mentioned embodiment 1, the forming of the plurality of grooves 4a in the inner surface of the ring-shaped waveguide 4 so that their depths extend along the radius of the reflecting plate produces a magnetic wall, as previously explained. The forming of the plurality of grooves 6b in the reflecting surface of the reflecting plate 6 so that their depths extend along the perpendicular direction can also produce a magnetic wall

Thus, the forming of the plurality of grooves 6b in the reflecting surface of the reflecting plate 6 so that their depths extend along the perpendicular direction can reduce the number of the grooves 4a formed in the inner surface of the ring-shaped waveguide 4, their depths extending along the radius of the reflecting plate.

As the ring-shaped waveguide 4 is lengthened, the beam diameter of the electric wave which is emitted toward the main reflector 5 is reduced. On the other hand, as the ring-shaped waveguide 4 is shortened, the beam diameter of the electric wave which is emitted toward the main reflector 5 is increased.

Therefore, when there is a need to form many grooves in the inner surface of the ring-shaped waveguide 4 without lengthening the ring-shaped waveguide 4 (the number of needed grooves differs dependently upon the frequency of the electric wave differs), for example, a plurality of grooves 6b are formed in the reflecting surface of the reflecting plate 6 so that their depths extend along the perpendicular direction.

As can be seen from the above description, in accordance with this embodiment 2, since the plurality of grooves 6b are formed in the reflecting surface of the reflecting plate 6 so that their depths extend along the perpendicular direction, a desired number of grooves can be formed without making the beam diameter of the electric wave which is emitted toward the main reflector 5 be smaller than necessary.

### Embodiment 3

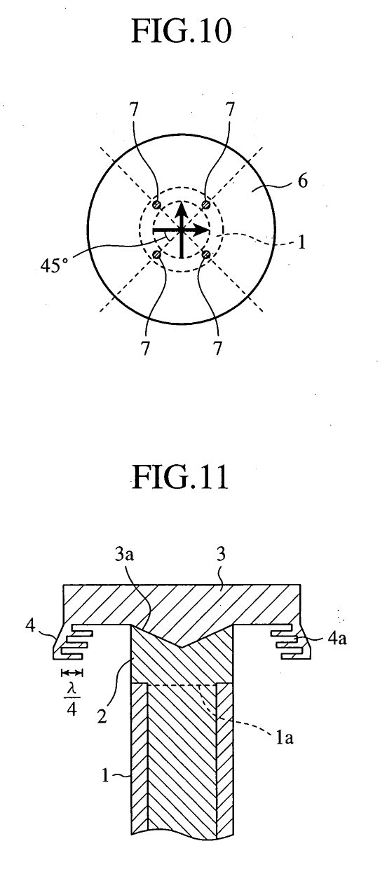

In above-mentioned embodiments 1 and 2, the other end of the dielectric member 2 which is not inserted into the circular waveguide 1 is attached to the disk-shaped reflecting plate 3 (for example, the other end of the dielectric member is attached to the disk-shaped reflecting plate with an adhesive or the like), as previously explained. As an alternative, as shown in FIGS. 9 and 10, the disk-shaped reflecting plate 6, dielectric member 2, and circular waveguide 1 can be secured to one another with dielectric screws 7.

While the disk-shaped reflecting plate 6 and circular waveguide 1 can be surely secured to each other, when four dielectric screws 7 are used, they are arranged at locations which deviate from the directions of the polarization of the eclectic wave by 45 degrees, respectively, in order to reduce the influence of the four dielectric screws 7 upon the electric wave.

In this embodiment 3, the dielectric screws 7 are arranged at different locations which deviate from the directions of the polarization of the eclectic wave by 45 degrees, as mentioned above. As an alternative, the dielectric screws 7 can be so arranged at different locations which deviate from the directions of the polarization of the eclectic wave by 0 degrees. In this variant, the same advantage can be provided.

### Embodiment 4

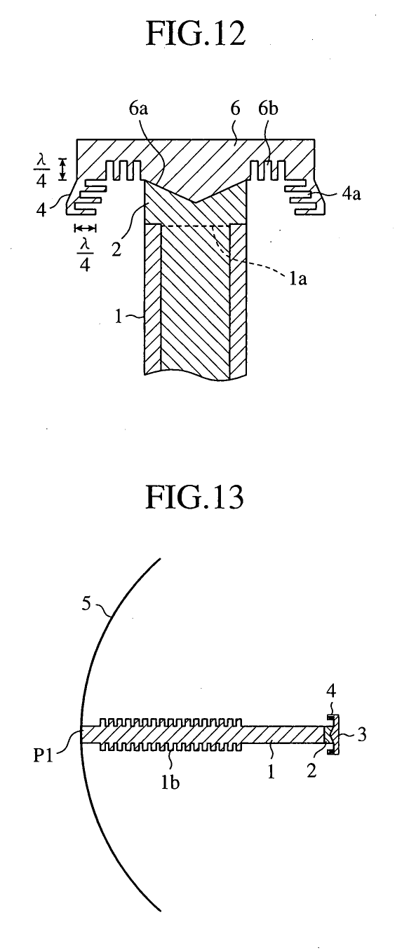

In above-mentioned embodiments 1 to 3, the ring-shaped waveguide 4 is disposed around the perimeter of the disk-shaped reflecting plate 3, as previously explained. In this embodiment, as shown in FIGS. 11 and 12, the ring-shaped waveguide 4 which is disposed around the perimeter of the disk-shaped reflecting plate 3 has an inner surface which is shaped like a trumpet.

Thus, since the inner surface of the ring-shaped waveguide 4 is shaped like a trumpet, that is, since the inner surface of ring-shaped waveguide 4 is formed so that it has a predetermined angle with respect a perpendicular direction, the electric wave which is emitted toward the main reflector 5 can be made to have a desired beam diameter.

### Embodiment 5

FIG. 13 is a block diagram showing an antenna apparatus in accordance with embodiment 5 of the present invention, and, in the figure, since the same reference numerals as shown in FIG. 1 denote the same components or like components, the explanation of the components will be omitted hereafter.

A plurality of grooves 1b are formed in an outer surface of a circular waveguide 1, and each of the grooves 1b has a depth which is one quarter the wavelength of an electric wave at a certain frequency.

In above-mentioned embodiments 1 to 4, since no grooves 1b are formed in the outer surface of the circular waveguide 1, the electric wave reflected by a disk-shaped reflecting plate 3 or 6 is emitted toward a main reflector 5, while it is subjected to the action of the electric wall of the circular waveguide 1.

In contrast, in accordance with this embodiment 5, since the plurality of grooves 1b are formed in the outer surface of the circular waveguide 1 so that a magnetic wall is produced, no current flows in the outer surface of the circular waveguide 1. Therefore, since no reemission from the circular waveguide 1 occurs, no unnecessary emission from the circular waveguide 1 can occur.

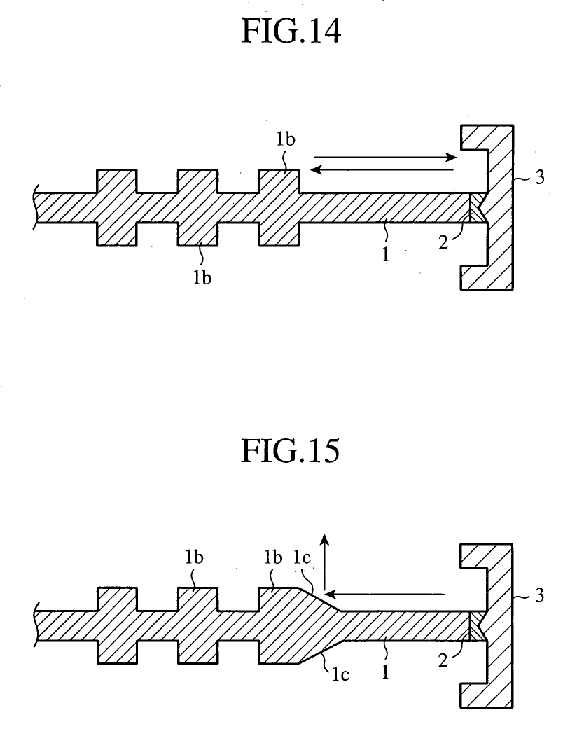

However, as shown in FIG. 14, there is a possibility that the electric wave reflected by the disk-shaped reflecting plate 3 is reflected by a side of a groove 1b and returns to the disk-shaped reflecting plate 3 when the plurality of grooves 1b are formed in the outer surface of the circular waveguide 1.

To solve this problem, in accordance with this embodiment 5, a tapered portion 1c is formed in a side of a groove 1b which is the nearest to the disk-shaped reflecting plate 3, as shown in FIG. 15.

Thereby, the electric wave reflected by the disk-shaped reflecting plate 3 can be prevented from being reflected by the side of the groove 1b and returning to the disk-shaped reflecting plate 3.

### INDUSTRIAL APPLICABILITY

As mentioned above, the antenna apparatus in accordance with the present invention is suitable for use in applications which, when mainly transmitting or receiving an electric wave lying within a VHF band, a UHF band, a microwave band, or a millimeter wave band, need to shape the radiation characteristic of the electric wave to a rotational symmetrical radiation characteristic.

1. An antenna apparatus comprising:
a first waveguide for transmitting an electric wave;
a disk-shaped reflecting plate for reflecting the electric wave emitted out of an aperture of said first waveguide; and
a ring-shaped second waveguide disposed around a perimeter of said reflecting plate, for shaping a radiation characteristic of the electric wave reflected by said reflecting plate to a rotational symmetrical radiation characteristic.

2. The antenna apparatus according to claim 1, characterized in that a groove is formed in an inner surface of the second waveguide so that its depth extends along a radius of the reflecting plate, and the depth of the groove is one quarter a wavelength of the electric wave at a certain frequency.

3. The antenna apparatus according to claim 2, characterized in that the first waveguide is a circular waveguide.

4. The antenna apparatus according to claim 2, characterized in that an end of a dielectric member is inserted into an interior of the first waveguide, and another end of the dielectric member which is not inserted into the first waveguide is attached to the disk-shaped reflecting plate.

5. The antenna apparatus according to claim 4, characterized in that the disk-shaped reflecting plate, the dielectric member, and the first waveguide are secured to one another with dielectric screws.

6. The antenna apparatus according to claim 5, characterized in that 2n dielectric screws (n=1, 2, 3, or . . . ) are used to secure the disk-shaped reflecting plate, the dielectric member, and the first waveguide to one another, and are arranged so that they are symmetric with respect to-a direction of polarization of the electric wave.

7. The antenna apparatus according to claim 1, characterized in that a groove is formed in a reflecting surface of the disk-shaped reflecting plate, and the groove has a depth which is one quarter a wavelength of the electric wave.

8. The antenna apparatus according to claim 1, characterized in that the second waveguide has an inner surface which is shaped like a trumpet.

9. The antenna apparatus according to claim 2, characterized in that a metallic projection is disposed in a reflecting surface of the disk-shaped reflecting plate.

10. An antenna apparatus comprising:
a first waveguide for transmitting an electric wave;
a disk-shaped reflecting plate placed at a location which is opposite to an aperture of said first waveguide, for reflecting the electric wave emitted out of the aperture of said first waveguide;
a ring-shaped second waveguide disposed around a perimeter of said reflecting plate, for shaping a radiation characteristic of the electric wave reflected by said reflecting plate to a rotational symmetrical radiation characteristic; and
a main reflector placed at a location which is just opposite to said disk-shaped reflecting plate, for reflecting the electric wave whose radiation characteristic is shaped by said ring-shaped reflecting plate.

11. The antenna apparatus according to claim 10, characterized in that a groove is formed in an inner surface of the second waveguide so that its depth extends along a radius of the reflecting plate, and the depth of the groove is one quarter a wavelength of the electric wave at a certain frequency.

12. The antenna apparatus according to claim 10, characterized in that a groove is formed in an outer surface of the first waveguide, and the groove has a depth which is one quarter a wavelength of the electric wave at a certain frequency.

13. The antenna apparatus according to claim 12, characterized in that a tapered portion is formed in a side of a groove which is located in a vicinity of the disk-shaped reflecting plate.
